(19) United States
(12) Patent Application Publication
(10) Pub. No.: US 2011/0283882 A1
(43) Pub. Date: Nov. 24, 2011

(54) Multiple-Layered Actuator Wall and Method of Manufacturing the Same

(76) Inventor: Frantz D. Stanford, Monona, WI (US)

(21) Appl. No.: 13/106,949

(22) Filed: May 13, 2011

Related U.S. Application Data
(60) Provisional application No. 61/347,677, filed on May 24, 2010.

(51) Int. Cl. F16J 10/02; B23P 11/00

(52) U.S. Cl. 92/169.1; 29/888.06; 29/888.061

(57) ABSTRACT

A linear actuator includes an actuator wall, and the actuator wall includes a first wall layer having an inner surface that defines an actuator chamber. The actuator chamber is configured to accommodate an actuator fluid. The first wall layer is also subjected to a pre-load such that the first wall layer is compressively pre-stressed. The actuator wall further includes a second wall layer disposed outwardly from the first wall layer. The linear actuator further includes a piston supported within the actuator chamber, and the piston is movable in response to the actuator fluid entering and exiting the actuator chamber.

### CROSS-REFERENCE TO RELATED APPLICATION

This application claims benefit to U.S. Provisional Application No. 61/347,677 filed May 24, 2010.

### STATEMENT CONCERNING FEDERALLY SPONSORED RESEARCH OR DEVELOPMENT

Not applicable.

### FIELD OF THE INVENTION

This invention relates to linear actuators, particularly hydraulic actuators having multiple-layered walls.

### BACKGROUND OF THE INVENTION

High-pressure hydraulic actuators typically operate at pressures in the range of 500-700 bar (˜7250-10150 psi). Ultra high-pressure hydraulic actuators operate at pressures greater than those of the above range. Considering these pressures, the walls of these actuators are subjected to high hoop stress. To resist this stress, actuator walls are typically thick (e.g., 1 inch or more) and comprise high-strength materials (e.g., a high-strength steel). However, the highest stress occurs at the inner surface of the actuator wall, and the stress decreases from the inner surface to the outer surface. As such, most actuator walls make inefficient use of material because high-strength materials are not needed in portions of the wall away from the inner surface.

Furthermore, some materials, such as some corrosion-resistant materials, cannot be considered for use in high-pressure hydraulic actuators due to their relatively low strength and the high stress near the inner surface of the actuator wall. However, the use of such materials could address drawbacks of actuators comprising high-strength materials, such as actuator corrosion.

Further still, in order to provide the high-strength and thick sections described above, actuator walls are typically manufactured by machining solid billet. Unfortunately, such a process wastes a large amount of material by cutting the billet to provide an internal actuator chamber. This causes relatively high manufacturing times and material costs, both of which are ultimately reflected in the cost of the final product.

Considering the above drawbacks, an improved actuator wall structure and a method for its manufacture are needed.

### SUMMARY OF THE INVENTION

In one aspect, the present invention provides a linear actuator comprising an actuator wall having a first end and a second end. The actuator wall includes a first wall layer that has an inner surface that partially defines an actuator chamber, and the actuator chamber is configured to accommodate an actuator fluid. The first wall layer is also subjected to a pre-load such that the first wall layer is compressively pre-stressed. The actuator wall further includes a second wall layer disposed outwardly from the first wall layer. The linear actuator further comprises a first actuator cap supported at the first end of the actuator wall and a second actuator cap supported at the second end of the actuator wall. The first and second actuator caps partially define the actuator chamber. The linear actuator further includes a piston supported within the actuator chamber, and the piston is movable in response to the actuator fluid entering and exiting the actuator chamber. A rod is supported by the piston so as to move with the piston, and the rod extends through the second actuator cap as the piston moves.

In another aspect, the present invention provides a linear actuator wall comprising a first wall layer having an inner surface defining an actuator chamber. The first wall layer comprises steel and is subjected to a pre-load such that the first wall layer is compressively pre-stressed. The linear actuator wall further comprises a second wall layer disposed radially outwardly from the first wall layer. The second wall layer comprises aluminum.

In yet another aspect, the present invention provides a method of manufacturing a linear actuator comprising the steps of: forming an actuator wall by: a) providing a first wall layer having an inner surface defining an actuator chamber, the actuator chamber being configured to accommodate an actuator fluid; b) providing a second wall layer; c) positioning the first wall layer within the second wall layer such that the first wall layer is subjected to a pre-load that compressively pre-stresses the first wall layer; and movably positioning a piston within the actuator chamber.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a longitudinal section view of a linear actuator wall according to the present invention;

FIG. 2 is a longitudinal section view of a linear actuator including the actuator wall of FIG. 1, a piston, a rod, and end caps; and

FIG. 3 is an exemplary stress chart of the actuator wall of FIG. 1 compared to a previous actuator wall structure.

### DETAILED DESCRIPTION OF THE PREFERRED EMBODIMENT

A linear actuator (e.g., a hydraulic actuator) according to the present invention includes an actuator wall having multiple layers. This multi-layered wall construction permits specific materials (e.g., high-strength materials, corrosion-resistant materials) to be used in specific areas where they are particularly useful (e.g., high-stress areas, corrosion-prone areas). The multi-layered construction also permits one or more of the layers to be pre-loaded such that the actuator wall is subjected to a lower maximum operating stress compared to previous actuator walls. Furthermore, the material of each layer and the magnitude of the pre-load can be specified based on other application-specific considerations and advantages. These aspects are described in further detail below.

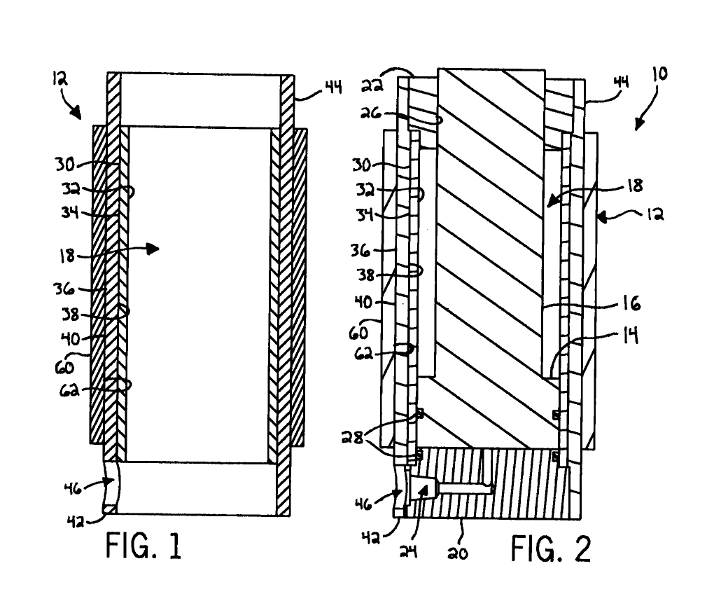

Referring to FIGS. 1 and 2, the linear actuator 10 includes an actuator wall 12 that is described in further detail below. Other components of the linear actuator 10 supported by the actuator wall 12 will first be briefly described.

Generally, the linear actuator 10 includes a piston 14 and a rod 16 disposed within a chamber 18 partially defined by the actuator wall 12. The piston 14 moves within the actuator chamber 18 as an actuator fluid (e.g., hydraulic oil) enters and exits the actuator chamber 18, and the rod 16 extends out of the chamber 18 by various amounts as the piston 14 moves. The actuator wall 12 also supports a first actuator cap 20 at a first end and a second actuator cap 22 at a second end, both of which also partially define the actuator chamber 18. The first actuator cap 20 includes an actuator fluid passageway 24 in fluid communication with the actuator chamber 18 for delivering and receiving the actuator fluid. The second actuator cap 22 includes a rod passageway 26 through which the rod 16 passes as the piston 14 moves. The actuator caps 20 and 22 and the piston 14 may support seals 28 (e.g., polymer o-rings) to prevent the actuator fluid from leaking from the actuator wall 12 or between the opposite sides of the piston 14.

Still referring to FIGS. 1 and 2 and as briefly described above, the actuator wall 12 has a multi-layered construction. Specifically, the actuator wall 12 includes a first wall layer 30 that has a generally open-cylindrical or tubular shape. That is, the first wall layer 30 has an inner surface 32 that defines the actuator chamber 18. The first wall layer 30 also has open first and second ends disposed proximate the first and second actuator caps 20 and 22, respectively. The first and second ends are preferably spaced apart such that the first wall layer 30 extends over the entire stroke of the piston 14. The first wall layer 30 also has an outer surface 34 opposite the inner surface 32.

The first wall layer 30 may comprise any of a variety of materials depending on, for example, application-specific considerations. For example, the first wall layer 30 may comprise a high-strength material, such as 0.25 inch thick 4140 chromium-molybdenum steel, to resist high stress near the inner surface 32 imparted by the pressurized actuator fluid. As another example, the first wall layer 30 may comprise a corrosion-resistant material, such as stainless steel, in applications where corrosion is a concern. As yet another example, the first wall layer 30 may comprise a relatively inexpensive material, such as 1045 carbon steel, to reduce costs if operating pressures are relatively low. As yet another example, the first wall layer 30 may comprise bronze to provide a bushing-like interface for engaging the piston 14. Other appropriate materials may also be used without departing from the scope of the invention.

The actuator wall 12 further includes a second wall layer 36 disposed radially outwardly from the first wall layer 30. Like the first wall layer 30, the second wall layer 36 has a generally open-cylindrical or tubular shape. That is, the second wall layer 36 includes an inner surface 38 that engages the outer surface 34 of the first wall layer 30 along the entire length of the first wall layer 30. The second wall layer 36 also has an outer surface 40 opposite the inner surface 38. The second wall layer 36 also includes first and second ends 42 and 44 that preferably extend past those of the first wall layer 30 and are spaced apart such that the second wall layer 36 extends over the entire stroke of the piston 14. Unlike the first wall layer 30, however, the first and second ends 42 and 44 of the second wall layer 36 may threadably engage the first and second actuator caps 20 and 22, respectively. The first end 42 of the second wall layer 36 also includes an actuator fluid opening 46 in fluid communication with the actuator fluid passageway 24 of the first actuator cap 20.

The second wall layer 36 may comprise any of a variety of materials depending on, for example, application-specific considerations and/or the material of the first wall layer 30. For example, to provide a relatively inexpensive support layer for the first wall layer 30, particularly if the first wall layer 30 comprises 4140 chromium-molybdenum steel, the second wall layer 36 may comprise 0.5 inch thick aluminum. As another example, the second wall layer 36 may comprise a medium-strength material, such as 1045 steel, particularly if the first wall layer 30 comprises stainless steel. Other appropriate materials may also be used without departing from the scope of the invention.

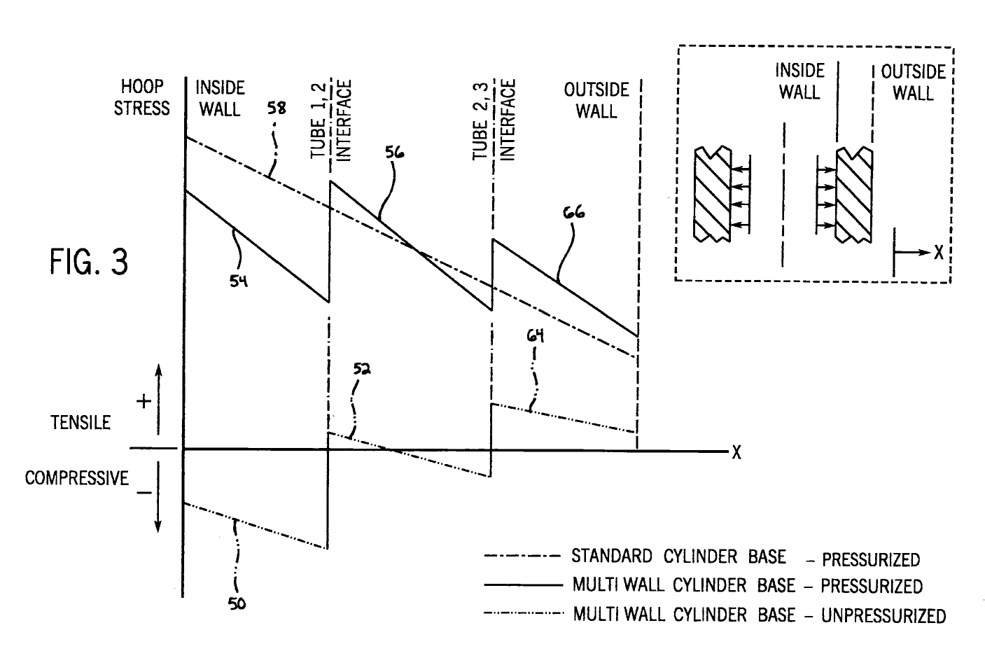

Referring now to FIG. 3, the first and second wall layers 30 and 36 are sized to provide an interference or press fit at the interface between the layers. That is, the diameter of the inner surface 38 of the second wall layer 36 is slightly smaller than the diameter of the outer surface 34 of the first wall layer 30. This size difference applies a pre-load to both of the wall layers 30 and 36. Specifically, the press fit applies a pre-load that compressively pre-stresses the first wall layer 30 (i.e., the pre-load forces the first wall layer 30 radially inwardly). This compressive pre-stress is shown at line segment 50 in FIG. 3. Conversely, the press fit applies a pre-load that tensively pre-stresses the second wall layer 36 (i.e., the pre-load forces the second wall layer 36 radially outwardly). This tensile pre-stress is shown at line segment 52 in FIG. 3. A portion of the second wall layer 36 may also be subjected to a compressive pre-stress due to another press fit as described in further detail below.

In operation (i.e., when the actuator chamber 18 is pressurized by actuator fluid), both wall layers 30 and 36 are subjected to tensile stress. This tensile stress is shown at line segments 54 and 56, respectively, in FIG. 3. However, the maximum stress experienced by the first wall layer 30 is relatively low compared to the maximum stress experienced by a previous actuator wall (shown at line segment 58) due to the compressive pre-stress. Furthermore, the tensile stress experienced by the second wall layer 36 is similar to the stress experienced by both the first wall layer 30 and the middle portion of a previous actuator wall.

Those skilled in the art will appreciate that the operating stress experienced by the first wall layer 30 may be further decreased by using a tighter interference fit. However, such a fit would also increase the pre-stress experienced by the first wall layer 30. Conversely, the operating stress experienced by the first wall layer 30 may be increased and the pre-stress experienced by the first wall layer 30 may be decreased by using a looser interference fit.

The previous paragraphs and the stress graph shown at line segments 54 and 56 in FIG. 3 illustrate several advantages of the actuator wall 12. For example and as described above, the material for each layer may be selected based on the maximum stress experienced by each wall layer instead of the overall maximum stress experienced by the actuator wall. As another example, the pre-stress experienced by the wall layers can provide a lower maximum stress and more uniform stress across the thickness of the wall for a given operating pressure compared to previous actuator walls. As such, the actuator wall 12 can include multiple layers of relatively low-strength materials for a given operating pressure, or the actuator wall 12 can include multiple layers with high-strength materials and operate at a higher pressure compared to previous actuator walls. As yet another example and as shown in FIG. 3, the second wall layer 36 may experience a higher maximum operating stress than the first wall layer 30. Such a phenomenon permits the first wall layer 30 to comprise a relatively low-strength material that provides other advantages (e.g., stainless steel) if the second wall layer 36, and any additional layers beyond the first wall layer 30, in total, is/are stiff and strong enough to support the first wall layer 30.

Returning now to FIGS. 1 and 2, the actuator wall 12 includes a third wall layer 60 that further reduces the stress experienced by the wall layers. However, in some embodiments, the actuator wall 12 may include only first and second wall layers 30 and 36. Further still, in other embodiments, the actuator wall 12 may include four or more layers, although manufacturing costs generally increase as the number of wall layers increases.

Like the first wall layer 30, the third wall layer 60 has a generally open-cylindrical or tubular shape and an inner surface 62 that engages the outer surface 40 of the second wall layer 36 along the entire length of the third wall layer 60. The third wall layer 60 also has open first and second ends disposed proximate the first and second ends 42 and 44 of the second wall layer 36, respectively. However, first and second ends of the third wall layer 60 are closer together than those of the second wall layer 36 and thereby define a shorter layer than the second wall layer 36. That is, the third wall layer 60 is relatively short and may only extend over the stroke of the piston 14.

The third wall layer 60 may comprise any of a variety of materials depending on, for example, application-specific considerations and/or the materials of the first and second wall layers 30 and 36. For example, the third wall layer 60 may comprise 0.375 inch thick high-strength steel, particularly if the first wall layer 30 comprises steel and the second wall layer 36 comprises aluminum, to prevent fatigue failure of the second wall layer. Other appropriate materials may also be used without departing from the scope of the invention.

Referring again to FIG. 3, like the first and second wall layers 30 and 36, the second and third wall layers 36 and 60 are sized to provide a press fit at the interface between the layers. That is, the diameter of the inner surface 62 of the third wall layer 60 is slightly smaller than the diameter of the outer surface 40 of the second wall layer 36. This size difference applies a pre-load to both of the wall layers 36 and 60. Specifically, the press fit applies a pre-load that compressively pre-stresses the second wall layer 36 (i.e., the pre-load forces the second wall layer 36 radially inwardly). This press fit, together with the press fit between the first and second wall layers 30 and 36, may subject one portion of the second wall layer 36 to a compressive pre-stress and another portion of the second wall layer 36 to a tensile pre-stress. It may also increase the compressive prestress on the first wall layer 30. Conversely, the press fit between the second and third wall layers 36 and 60 applies a pre-load that tensively pre-stresses the third wall layer 60 (i.e., the pre-load forces the third wall layer 60 radially outwardly). This tensile pre-stress is shown at line segment 64 in FIG. 3.

In operation, the third wall layer 60 is subjected to tensile stress. This tensile stress is shown at line segment 66 in FIG. 3. Furthermore, the stress experienced by the third wall layer 60 is similar to the stress experienced by both the first wall layer 30 and the second wall layer 36, although it is slightly greater than the stress experienced by the outer portion of a standard actuator wall. As such, stress on the actuator wall 12 may be more uniform across the thickness of the wall compared to previous actuator walls.

The linear actuator 10 is preferably manufactured as follows. First, three pieces of tube stock are cut to appropriate lengths for providing the first wall layer 30, the second wall layer 36, and the third wall layer 60. The pieces of tube stock preferably have the nominal inner and outer diameters of the first wall layer 30, the second wall layer 36, and the third wall layer 60, respectively. However, it is unlikely that the pieces of tube stock will be accurately sized for providing the desired interference and pre-load between the wall layers. As such, the pieces of tube stock are then ground or honed to provide these dimensions. Next, the first wall layer 30 is slid into the second wall layer 36 to provide the press fit there between, and the second wall layer 36 is slid into the third wall layer 60 to provide the press fit there between. The piston 14 and the rod 16 are then positioned within the actuator chamber 18, and the actuator caps 20 and 22 are then connected to the actuator wall 12.

The steps of the above manufacturing method may be varied without departing from the scope of the invention. For example, high forces are needed to slide the wall layers relative to one another and thereby provide the press fits. As such, the press fits may be provided in other manners, such as heat shrinking. Furthermore, if the first wall layer 30 becomes worn during use, it may be removed and replaced by a new first wall layer 30.

The hoop stress experienced by the actuator wall may be more uniform across the thickness of the wall compared to previous actuator designs, and appropriate materials for each layer may be selected accordingly. Similarly, the maximum operating stress experienced by the actuator wall for a given operating pressure is less than that experienced by similarly-sized previous actuator designs. As such, a linear actuator according to the present invention can be operated at higher pressures compared to previous actuator designs. Furthermore, the multi-layered construction of the actuator wall permits specific materials (e.g., high-strength materials, corrosion-resistant materials) to be used in specific areas where they are particularly useful (e.g., high-stress areas, corrosion-prone areas). Particularly, in some cases the multi-layered construction permits relatively low-strength materials to be used for the inner wall layer. Further still, manufacturing methods for the actuator wall use tube stock instead of wasting a large amount of material by machining solid billet.

A preferred embodiment of the invention has been described in considerable detail. Many modifications and variations to the preferred embodiment described will be apparent to a person of ordinary skill in the art. Therefore, the invention should not be limited to the embodiment described, but should be defined by the claims that follow.

I claim:

1. A linear actuator comprising:
an actuator wall having a first end and a second end and including:
a first wall layer having an inner surface partially defining an actuator chamber, the actuator chamber being configured to accommodate an actuator fluid, the first wall layer being subjected to a pre-load such that the first wall layer is compressively pre-stressed;
a second wall layer disposed outwardly from the first wall layer;
a first actuator cap supported at the first end of the actuator wall and partially defining the actuator chamber;
a second actuator cap supported at the second end of the actuator wall and partially defining the actuator chamber;
a piston supported within the actuator chamber, the piston being movable in response to the actuator fluid entering and exiting the actuator chamber; and
a rod supported by the piston so as to move with the piston, the rod extending through the second actuator cap as the piston moves.

2. The linear actuator of claim 1, wherein a press fit between the first wall layer and the second wall layer provides the pre-load such that the first wall layer is compressively pre-stressed.

3. The linear actuator of claim 1, wherein each of the first wall layer and the second wall layer has a generally tubular shape.

4. The linear actuator of claim 1, wherein each of the first wall layer and the second wall layer extends over the entire stroke of the piston.

5. The linear actuator of claim 1, further comprising a third wall layer disposed outwardly from the second wall layer.

6. The linear actuator of claim 5, wherein a press fit between the second wall layer and the third wall layer provides a pre-load such that the second wall layer is compressively pre-stressed.

7. The linear actuator of claim 5, wherein each of the first wall layer, the second wall layer, and the third wall layer extends over the entire stroke of the piston.

8. The linear actuator of claim 1, wherein the first wall layer comprises a first material and the second wall layer comprises a second material different from the first material.

9. The linear actuator of claim 8, wherein the first material is steel and the second material is aluminum.

10. The linear actuator of claim 8, wherein the first material is bronze.

11. A linear actuator wall, comprising:
a first wall layer having an inner surface defining an actuator chamber, the first wall layer comprising steel and being subjected to a pre-load such that the first wall layer is compressively pre-stressed; and
a second wall layer disposed radially outwardly from the first wall layer and comprising aluminum.

12. The linear actuator wall of claim 11, wherein a press fit between the first wall layer and the second wall layer provides the pre-load such that the first wall layer is compressively pre-stressed.

13. The linear actuator wall of claim 12, further comprising a third wall layer disposed radially outwardly from the second wall layer and comprising steel, and wherein a press fit between the second wall layer and the third wall layer provides the pre-load such that the second wall layer is compressively pre-stressed.

14. The linear actuator of claim 13, wherein each of the first wall layer, the second wall layer, and the third wall layer has a generally cylindrical shape.

15. A method of manufacturing a linear actuator, comprising the steps of:
forming an actuator wall by:
a) providing a first generally-cylindrical wall layer having an inner surface defining an actuator chamber, the actuator chamber being configured to accommodate an actuator fluid;
b) providing a second generally-cylindrical wall layer;
c) positioning the first generally-cylindrical wall layer within the second generally-cylindrical wall layer such that the first generally-cylindrical wall layer is subjected to a pre-load that compressively pre-stresses the first generally-cylindrical wall layer; and
movably positioning a piston within the actuator chamber.

16. The method of claim 15, wherein step c) includes press fitting the first generally-cylindrical wall layer within the second generally-cylindrical wall layer such that the first generally-cylindrical wall layer is subjected to the pre-load that compressively pre-stresses the first generally-cylindrical wall layer.

17. The method of claim 15, wherein step a) includes cutting a first piece of tube stock to provide the first generally-cylindrical wall layer, and step b) includes cutting a second piece of tube stock to provide the second generally-cylindrical wall layer.

18. The method of claim 15, wherein the first generally-cylindrical wall layer comprises a first material and the second generally-cylindrical wall layer comprises a second material different than the first material.

19. The method of claim 18, wherein the first material is steel and the second material is aluminum.

20. The method of claim 15, further comprising the step of removing and replacing the first generally-cylindrical wall layer with another first generally-cylindrical wall layer if the first generally-cylindrical wall layer becomes worn.
